(19) United States
(12) Patent Application Publication
(10) Pub. No.: US 2022/0002128 A1
(43) Pub. Date: Jan. 6, 2022

(54) TELESCOPING ELECTRIC CAMERA CRANE

(71) Applicant: CHAPMAN/LEONARD STUDIO EQUIPMENT, INC., North Hollywood, CA (US)

(72) Inventor: Leonard T. CHAPMAN, North Hollywood, CA (US)

(21) Appl. No.: 17/480,044

(22) Filed: Sep. 20, 2021

Related U.S. Application Data
(63) Continuation-in-part of application No. 16/844,688, filed on Apr. 9, 2020.

(51) Int. Cl. B66F 11/04; F16M 11/42; F16M 11/18; G03B 17/56

(52) U.S. Cl. CPC B66F 11/048; F16M 11/42; F16M 2200/041; G03B 17/561; F16M 11/18

(57) ABSTRACT

A camera crane cart may include a frame supported on wheels and a frame deck on the frame. A riser may be provided on the frame extending above the frame deck. A top plate at the top of the riser is adapted for supporting a camera crane. The crane cart may have a handle attached to a front of the frame. Each of the frame, the frame deck, the riser and the top plate has an opening to allow a camera dolly arm to move into a central location of the camera crane cart for loading or unloading a camera crane from the camera dolly onto or off of the crane cart.

### CROSS-REFERENCE TO RELATED APPLICATION

The present application is a continuation-in-part of, and claims priority to, pending U.S. patent application Ser. No. 16/844,688, filed Apr. 9, 2020, which is incorporated herein in its entirety by reference.

### BACKGROUND OF THE INVENTION

The field of the invention is camera cranes. Camera cranes are often used in motion picture and television production. The motion picture or television camera is typically mounted on the front end of a crane arm with counterweights at the back end of the crane arm. The crane arm is pivotally supported on a base to allow the crane arm to tilt up and down and pan from side-to-side. The base is typically supported on a camera dolly, wheeled mobile base, or truck.

Telescoping camera cranes have a telescoping arm that can extend and retract, providing far more capability than fixed length crane arms. However, existing telescoping camera cranes generally weigh several hundred kilograms, which exceeds the safe load carrying capacity of small portable camera dollies. Consequently, for filming in confined or less accessible spaces where only a small portable camera dolly can be used, historically there have been limited telescoping camera crane designs.

Of course, existing telescoping camera cranes can be made smaller which also makes them lighter. However, regardless of the size, the camera crane must be able to consistently hold the camera (and various associated payloads such as a remote camera head) in a steady position, even with the arm fully extended. As the camera crane size is reduced, the smaller structural components of the camera crane have reduced capability to resist unintended or undesirable camera movements, due to bending, flexing, twisting, or vibration.

Various types of electric telescoping camera cranes have been used in the past. These types of camera cranes typically use wall current or a remote battery to operate one or more electric motors to drive the telescoping operation. Using wall current requires connecting the crane to a power source via a cable, which can limit the flexibility of use of the crane. Accordingly, engineering challenges remain in designing a lightweight and compact telescoping camera crane.

### SUMMARY OF THE INVENTION

A camera crane cart may include a frame supported on wheels and a frame deck on the frame. A riser may be provided on the frame extending above the frame deck. A top plate at the top of the riser is adapted for supporting a camera crane. The crane cart may have a handle attached to a front of the frame. Each of the frame, the frame deck, the riser and the top plate has an opening to allow a camera dolly arm to move into a central location of the camera crane cart for loading or unloading a camera crane from the camera dolly onto or off of the crane cart.

In a method for unloading a camera crane from a camera dolly, a camera dolly carrying a camera crane on an arm of the camera dolly is maneuvered into an opening of a crane cart. The camera dolly arm is lowered to set the camera crane onto a top plate of a riser of the crane cart. The crane may be secured to the crane cart via one or more fasteners. The camera dolly is then withdrawn from the crane cart. The method allows loading and unloading the crane without the need for lifting the crane by hand.

Other aspects and features are shown in the drawings, which show one example of how the lightweight camera crane may be designed, and which are not intended to specify a limit on the scope of the invention.

### BRIEF DESCRIPTION OF THE DRAWINGS

In the drawings, the same element number indicates the same element in each of the views.

FIG. 1 is a top, rear and right side perspective view of a prior art lightweight telescoping camera crane.

FIG. 2 is an exploded perspective view of the prior art camera crane as it is shown in FIG. 1.

FIG. 3 is a similar exploded perspective view of major elements of the prior art camera crane shown in FIGS. 1 and 2, with components removed for purpose of illustration.

FIG. 4 is a side view of the prior art camera crane of FIGS. 1 and 2 with the base and trim weight platform removed.

FIG. 5A is a rear view of the prior art camera crane of FIG. 4.

FIG. 5B is a view similar to FIG. 5A but with the nose assembly removed, for purpose of illustration.

FIG. 6 is a section view taken along line 6-6 of FIG. 4, with the counterweight carriage removed.

FIG. 7 is a top view of the prior art crane shown in FIGS. 1-6.

FIG. 8 is a perspective view of a new camera crane similar in aspects to the design shown in FIGS. 1-7 and further including an electrical unit.

FIG. 9 is an exploded perspective view of the camera crane of FIG. 8.

FIG. 10 is a perspective view of the electrical unit shown in FIGS. 8 and 9.

FIG. 11 is a front view of the electrical unit shown in FIG. 8.

FIG. 12 is a side view showing examples of dimensions of the camera crane of FIGS. 8-11.

FIG. 13 is a side view of the camera crane of FIGS. 8-12 mounted on a camera dolly, with the camera crane in a fully retracted position and the dolly arm in a fully down position.

FIG. 14 is a side view of the camera crane of FIGS. 8-12 mounted on a camera dolly, now with the camera crane in a fully extended position and the dolly arm in a fully up position.

FIG. 15 is a side view of the camera crane of FIGS. 8-12 with a camera on a camera head in an over-slung position.

FIG. 16 is a perspective view of an alternative electrical unit.

FIG. 17 is a perspective view of crane cart.

FIG. 18 is a perspective view of a camera dolly positioning the crane of FIG. 8 for transfer to the crane cart of FIG. 17.

FIG. 19 is a perspective view of the camera crane of FIGS. 8 and 18 now transferred to the crane car of FIG. 17.

### DETAILED DESCRIPTION OF THE DRAWINGS

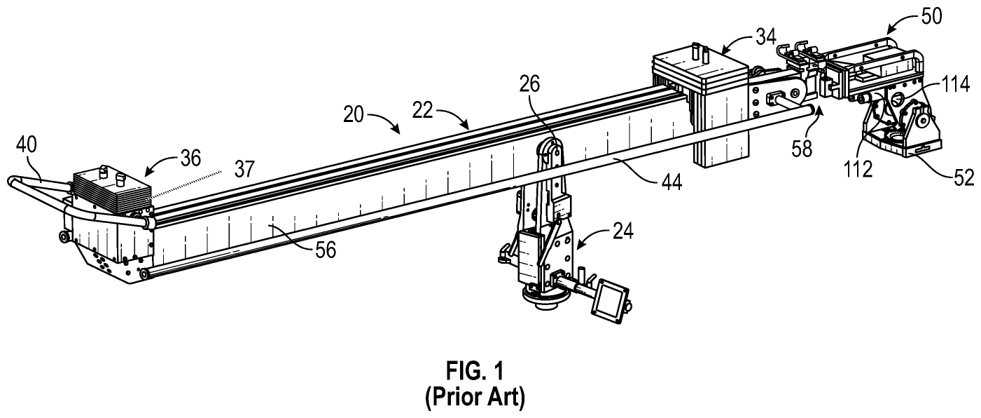

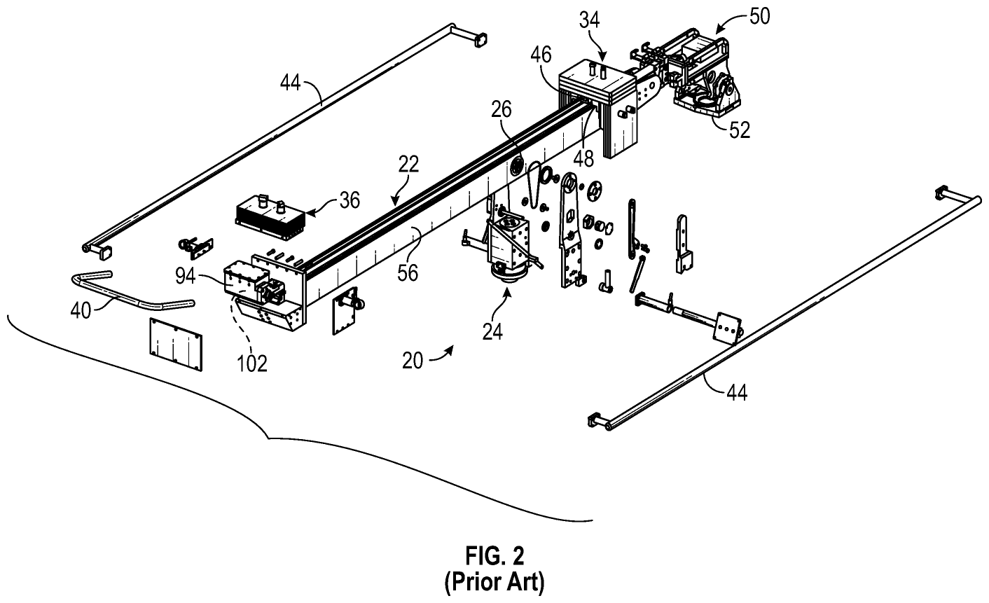

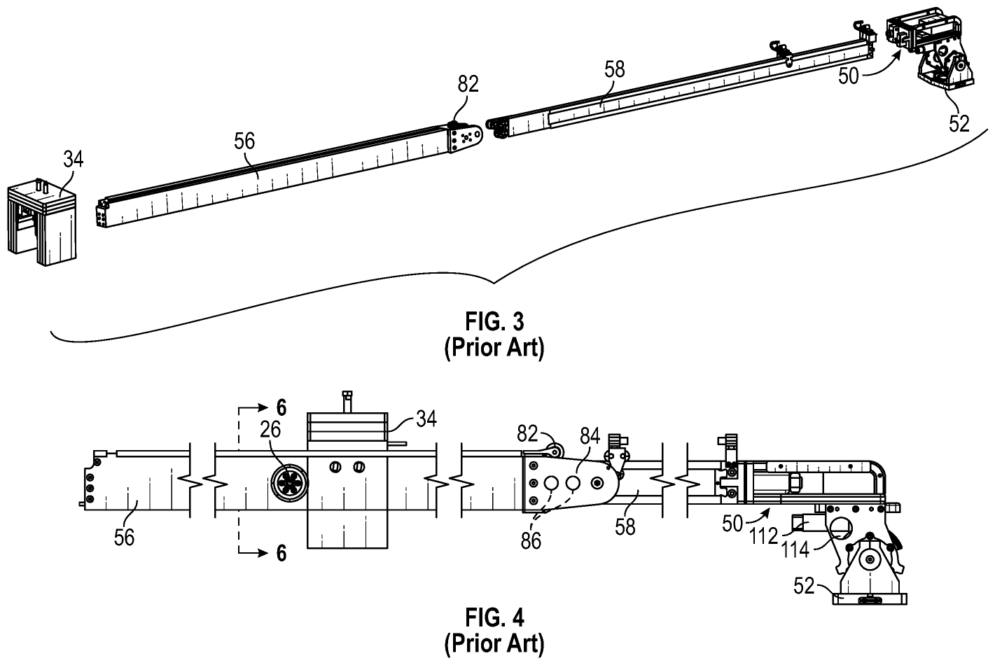

FIGS. 1-7 show a camera crane as disclosed in Chapman U.S. Pat. No. 9,507,244, incorporated herein by reference. As shown in FIGS. 1 and 2, a camera crane 20 has a crane arm 22 including an outer arm 56 and an inner arm 58 telescopically extendible into and out of the outer arm 56. The base has a left base plate on a left side of the outer arm and a right base plate on a right side of the outer arm, with the outer arm pivotally attached to the base via left and right axles 26 on the left and right base plates. Handles are attached to the outer arm 56, such as a rear handle 40 and side handles 44, to allow the crane arm 22 to be easily grasped, moved, or held into a desired position. A nose frame 50 is rigidly attached, e.g., bolted, onto the front end of the inner arm. The camera 406 is attached to the mounting plate 52. The nose frame 50 may be magnesium, to reduce weight. Referring now also to FIGS. 3 and 4, one or more tilt motors 112 acting through a tilt gear drive or linkage 114 pivot the mounting plate 52 as required to keep the mounting plate (and the camera on the mounting plate) level, regardless of the tilt angle of the crane arm 22.

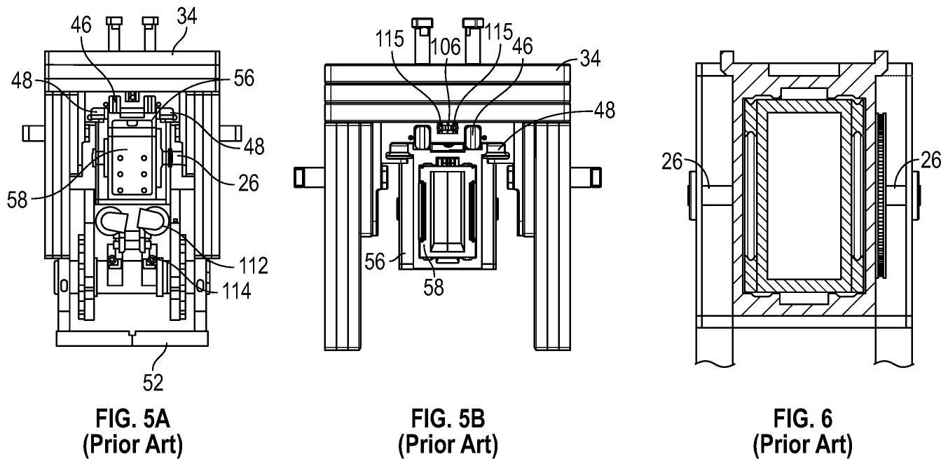

A counterweight carriage 34 rolls on a top surface of the outer arm 56 to keep the crane arm 22 balanced as the inner arm 58 extends and retracts. Specifically, as shown in FIGS. 2 and 5B, the counterweight carriage 34 has top rollers 46 which roll on a top surface of the outer 56, and side rollers 48 which roll on the sides of the outer arm 56. The counterweight carriage 34 typically carries a fixed number of counterweight plates 37 selected so that the crane arm 22 is balanced regardless of the position of the inner arm, with a minimum payload or no payload on the mounting plate 52. The weights on the counterweight carriage may be changed as needed if the nose frame 50 is replaced with a heavier or lighter nose assembly.

As shown in FIGS. 1 and 2, a trim weight tray 36 is attached to the back end of the outer arm 56. Trim weight plates are added to or removed from the trim weight tray to balance the crane arm 22 after the payload is attached to the nose frame 50 and the camera crane 20 is ready for use. Sliding or rolling trim weights may be provided on the side handles for making small balance adjustments.

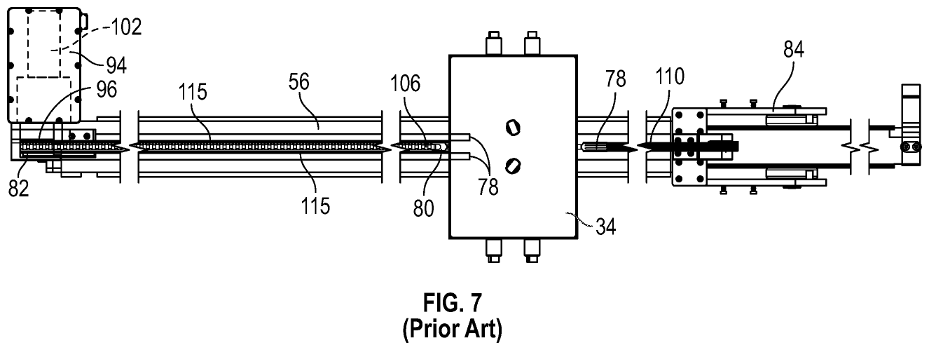

Referring now to FIG. 2, an extension motor 102 drives a sprocket through a gear drive within a motor enclosure 94 at the back end of the outer arm 56. The gear reduction may have a drive ratio of 2-6, to allow for manually moving the inner arm by back driving the motor. A first end of a chain 106 is attached to the back end of the counterweight carriage 34. The chain wraps around the sprocket with the other end of the chain attached to the back end of the inner arm 58. As shown in FIG. 7, two rear cables 115 run alongside of the chain 106, with one end of each cable attached to the back end of the counterweight carriage 34 via a cable anchor 78, and with the other end of each cable attached to near the back end of the inner arm. The chain and cable anchors allow tension to be adjusted.

A first end of each of a group of three front cables 110 is attached to a front end of the counterweight carriage 34 via a first cable anchor 78, with the cables running over pulleys 82 on the front end of the outer arm 56, and with second end of each front cable 110 attached to the inner arm 58 via a second cable anchor 78 adjacent to, and in front of, the first chain anchor 80. The chain 106 may be replaced by a belt and the front cables 110 may be replaced by a chain or belt. The chain may be a silent chain having stacked rows of flat tooth-shaped driving links meshed with the sprocket. The extension motor 102 is powered via an electrical cable connected to batteries or other power supply typically carried on the camera dolly. The extension motor 102 may be controlled via a wireless controller carried by the crane operator, or via a hand control attached or tethered to the camera crane 20.

The inner arm is telescopically extended using a wired or wireless control which controls the extension motor 102. When the motor is actuated to extend, the extension motor 102 turns the sprocket causing the chain 106 to pull the counterweight carriage 34 towards the rear of the crane arm 22. Simultaneously, the front cables 110 pull the inner arm forward, extending the inner arm. The extension motor 102 and gear drive 96 may be selected so that they can be readily back-driven, by pushing or pulling on inner arm 58 with a nominal force of e.g., 90 to 225 Newtons. This allows the inner arm 58 to be manually telescopically moved in or out, without using the motor.

The arm is retracted by operating the extension motor 102 in the reverse direction, with the chain 106 pulling the inner arm back into the outer arm, and with the front cables pulling the counterweight carriage towards the front of the crane arm 22. The electronic controller of the extension motor 102 may be linked to sensors which detect the position of the counterweight carriage, to decelerate the counterweight carriage automatically as it approaches the front or rear limit of travel. In the example shown with an outer arm 56 about length of about 300 cm, the inner arm travel is about 215 cm. Modifications of the camera crane of FIGS. 1-7 as described in U.S. patent application Ser. No. 16/844,688, incorporated herein by reference, may also be used.

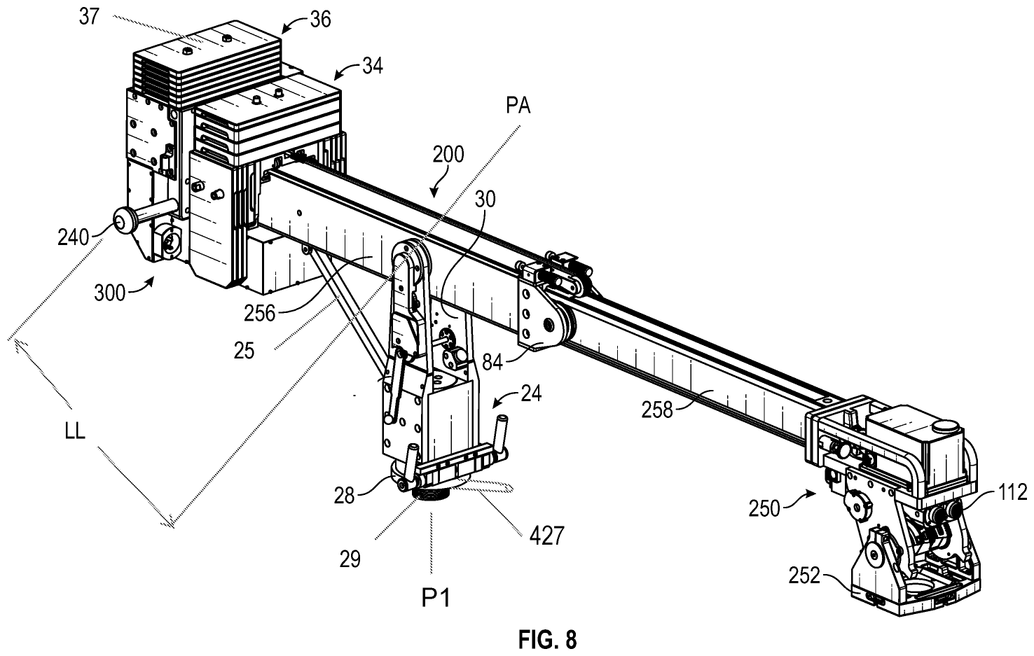

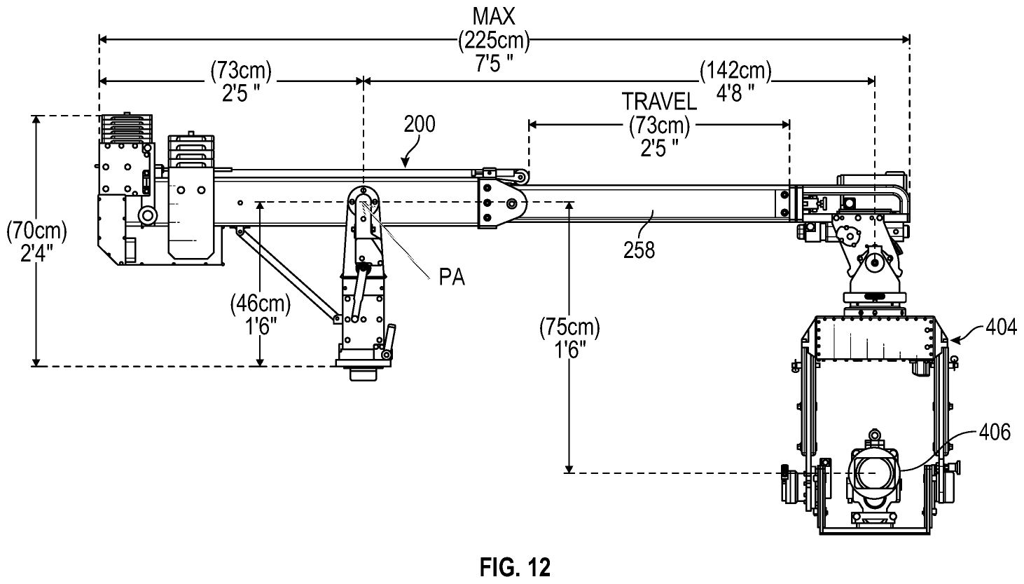

Turning to FIGS. 8-15, a new camera crane 200 may be similar or the same as the camera crane shown in FIGS. 1-7, except as described below. The camera crane 200 has an inner tube 258 telescopically movable into and out of an outer tube 256. The inner tube 258 and the outer tube 256 may have the same size and cross section as the inner and outer tubes 58 and 56, except they are much shorter. For example, as shown in FIG. 12, the inner and outer tubes 258 and 256 form a camera crane 200 having an overall extended total length of about 200 to 230 cm (nominally 215 cm), and an overall retracted length of about 130 to 170 cm (nominally 153 cm), including the nose frame 250. The nose frame 250 on the camera crane 200 is proportionally smaller than the nose frame 50. As a result, the camera crane 200 is highly compact and can be used in spaces providing little room to operate, particularly indoor spaces, such as a typical bedroom or bathroom. As shown also in FIG. 12, the inner tube 258 has a telescoping travel range of about 60 to 85 cm (nominally 73 cm). Since the camera crane 200 is shorter than the camera crane 20 shown in FIGS. 1-7, the inner tube 258 may be supported on a single pair of front rollers at the front end of the outer tube, rather than the two pairs of rollers 86 shown in FIG. 4. FIGS. 1-7 show the camera crane 20 without a column.

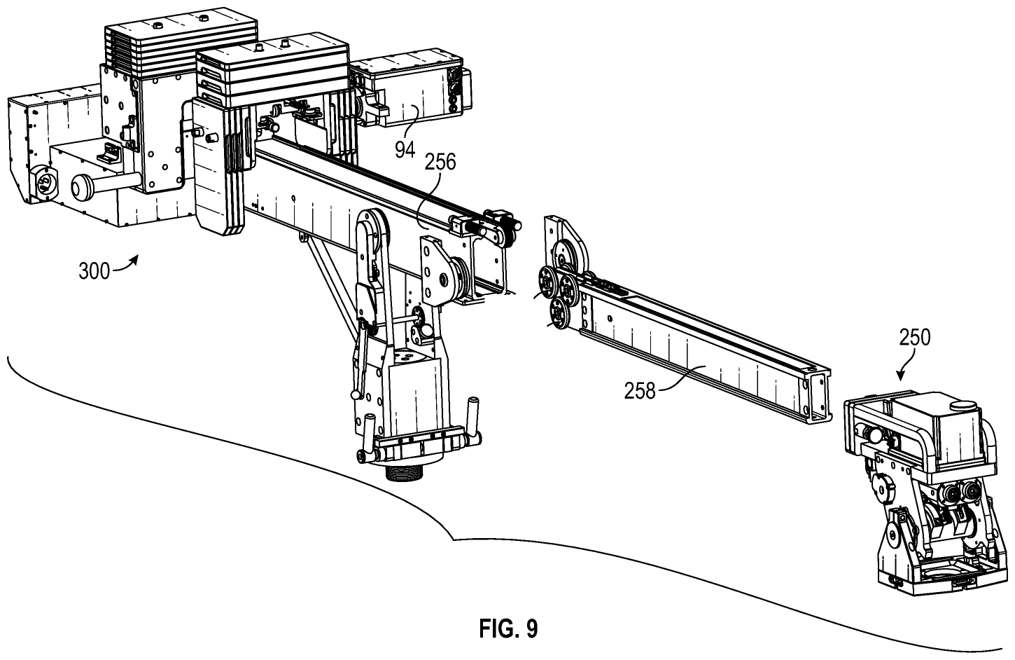

FIG. 8 shows the crane 200 mounted on a column 24 rotatably attached to a base plate 28, to allow the crane 200 to rotate about the pan axis P1. The crane 200 is pivotally attached to the column 24 on a tilt axis P2. The strut 25 between the column 24 and the back end of the crane 200, shown in FIGS. 8-9, holds the crane 200 in a horizontal position. The strut 25 is removed before rotating the crane 200 about the tilt axis P2.

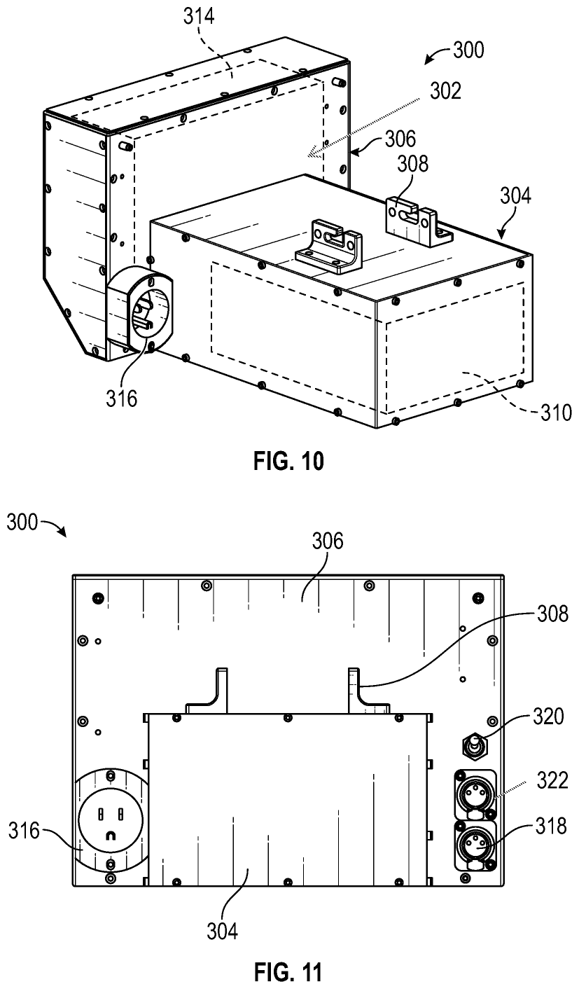

As shown in FIGS. 9-11, an electrical unit 300 is attached to the back end of the camera crane 200. The electrical unit 300 has a housing 302 including a battery section 304 and a charger section 306. Brackets or hooks 308 on the top surface of the battery section 304 may be used to attach the electrical unit 300 onto the outer tube 256. Ordinarily though the electrical unit 300 is permanently attached to and a permanent part of the camera crane 200. A rechargeable battery 310, such a 32 or 36 VDC lithium cell battery, is enclosed within the battery section 304 of the housing 302. The battery 310 and the battery section 304 both have a rectangular cross section, as shown in FIG. 10. Charging and switching circuitry is enclosed within the charger section 306 of the housing 302. The charger section 306 may also be generally rectangular. As shown in FIG. 8, the battery section 304 is wider than the outer tube 256, but sufficiently narrow to fit between the side counterweight plates 37 when the counterweight carriage 34 is in the full back position.

Referring to FIG. 11, an AC input socket or connector 316 is provided on one side of the charger section 306 and an on/off switch 320, a DC output connector 318, and a battery charging connector 322 are provided on the other side of the charger section 306. The AC input socket 316 is wired to the AC/DC converter 314 which converts 110/220 VAC wall current to DC which operates the extension motor, if the battery 310 is insufficiently charged. The battery charging connector 322 charges the battery when connected to an external charging source. The switch 320 powers the electrical system on or off.

In ordinary use, with the battery charged, electrical power to the extension motor 102 is provided from the battery 310. The battery may also power the tilt motors 112 via a cable from the connector 318 extending forward to the tilt motors 112 on nose frame 250, or it may be used to provide 32 or 36 VDC to an accessory or to the camera 406. With the battery charged, no power cable from facility wall current or a generator is needed. This allows the camera crane 200 to be used in remote locations, without a generator. It also allows the camera crane 200 to be used anywhere, without the need for a facility power cable or a generator.

The camera crane 200 may optionally be powered by wall current, via a 110/220 VAC cable connected to the socket 316. In this case, the AC current is converted by the AC/DC converter to 32 or 36 VDC which is used to power the extension motor 102, tilt motors 112 and accessories or the camera. Alternatively, an external accessory battery may be used to power the camera crane 200. The charging and switching circuitry automatically detects the power source, if any, connected to the socket 316 and internally switches in the AC/DC converter, as needed.

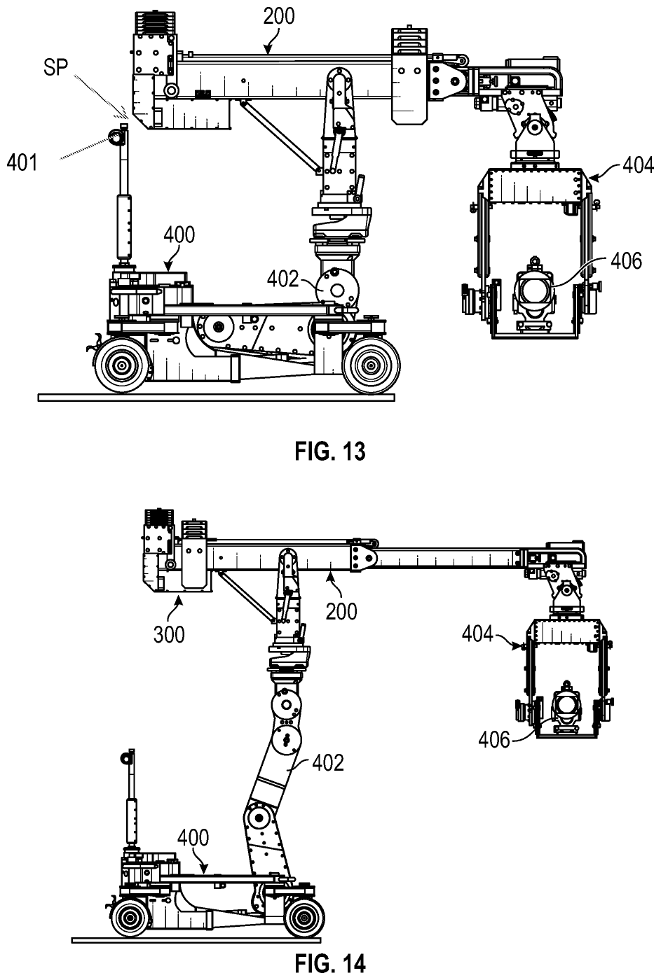

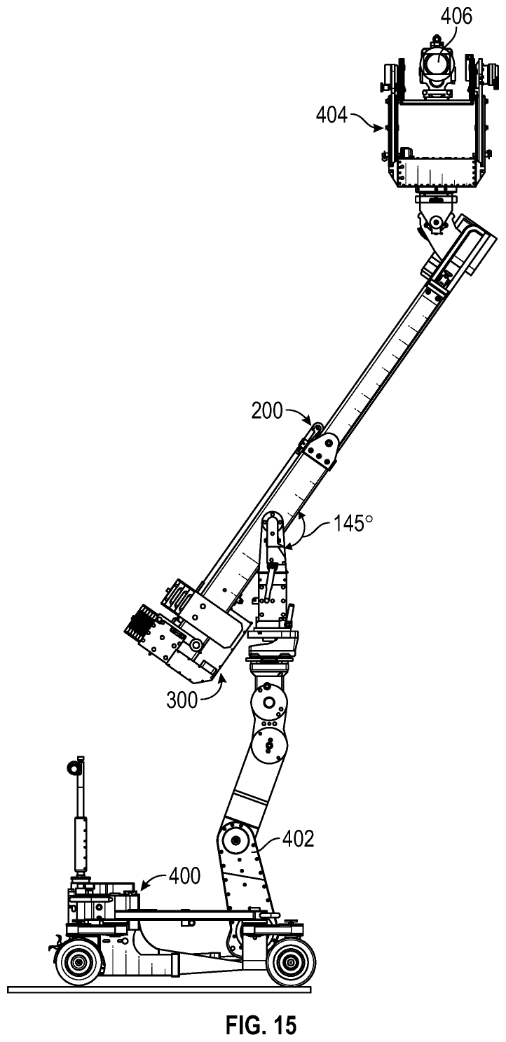

FIGS. 13-15 show examples of use of the camera crane 200 mounted on a camera dolly 400. FIG. 13 shows the camera crane 200 in a fully retracted position, and the dolly arm 402 in a full down position. A camera head 404 is attached to the mounting plate 52 in the so-called under-slung position and a camera 406 is mounted on the camera head 404. FIG. 14 shows the same set up now with the camera crane 200 fully extended and the dolly arm 402 in the full up position. FIG. 15 also shows the camera crane 200 fully extended and the dolly arm 402 in the full up position, but with the camera crane 200 tilted up and with the camera head in the so-called over-slung position.

In an alternative design, the extension motor is operated only by the battery. The battery is charged by connecting 110/220 AC to the camera crane, wherein it is converted to 32 or 36 VDC for charging the battery. In this design, there is no direct electrical connection from the AC converting circuit to the extension motor.

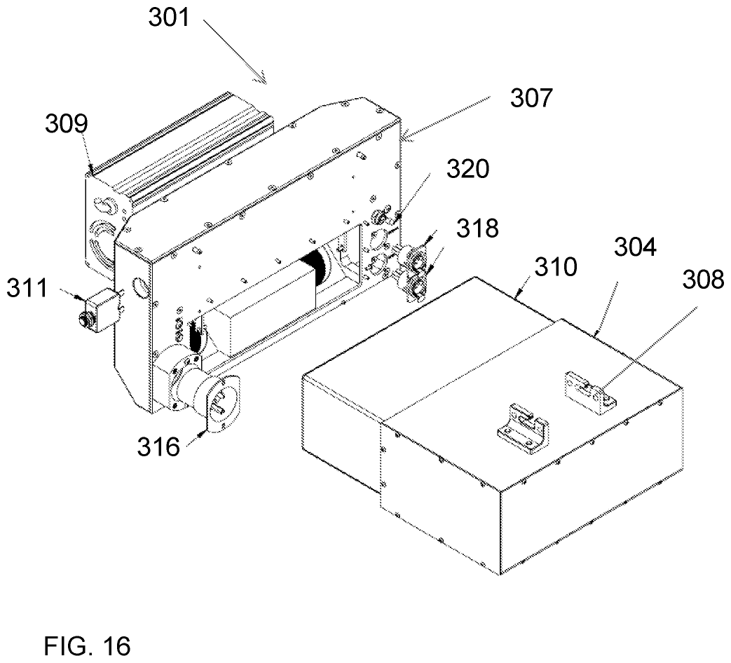

FIG. 16 shows an alternative electrical unit 301 having an external battery charger 309 attached to a housing 307, and a thermal circuit breaker 311.

In the design of FIG. 12, the tilt pivot axis PA through the axles 26 is 73 cm from the back end of the crane. In the design of FIG. 8, the dimension LL from the back end of the crane to the tilt pivot axis PA is increased by 4 or 8 to 20 cm, to increase the clearance space SP shown in FIG. 13, even if the housing 307 is larger than the charger section 306 of the electrical unit 300 shown in FIGS. 10-11. This provides additional space for the operator's hands on the steering handle 401, even with the steering handle at the 90° position shown in 18.

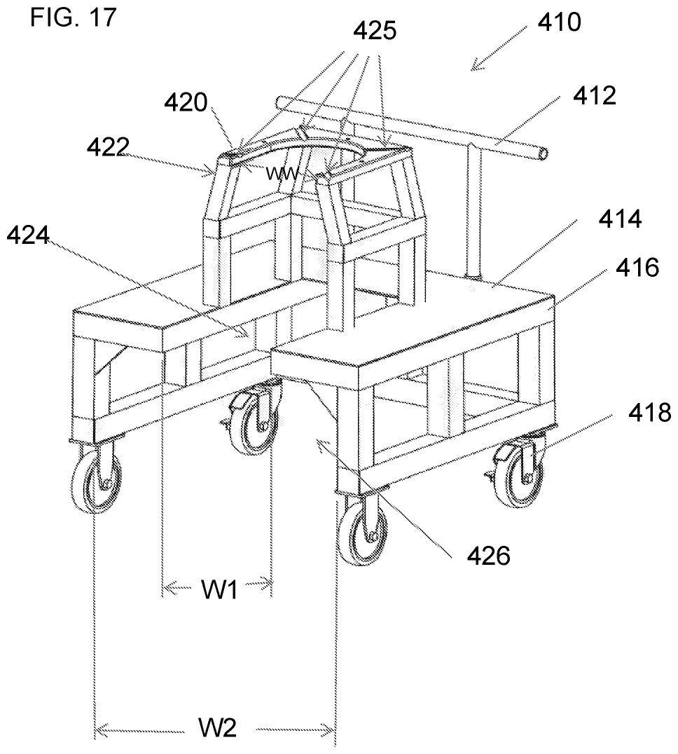

Turning to FIG. 17, a crane cart 410 has a frame 416 supported on wheels 418. A riser 422 is attached to a deck 414 of the frame 416. The deck 414 is generally U-shaped. A deck opening 424 extends into a center area of deck. The deck opening 424 has a length equal to 40 to 80% of the length of the deck 414. The deck opening 424 has a width W1. A frame opening 426 below the deck 414 has a width W2 which may be 1.5 to 3 times greater than W1. A handle bar 412 is attached to a front end of the frame 416. A U-shaped top plate 420 on top of the riser 422 and may include four equally spaced apart radial slots or grooves 425. As used here, U-shaped includes shapes having sharp corners rather than a radius, as shown in FIG. 17. The crane cart 410 may be provided as a weldment or assembly of steel or aluminum tubes, bars or channels.

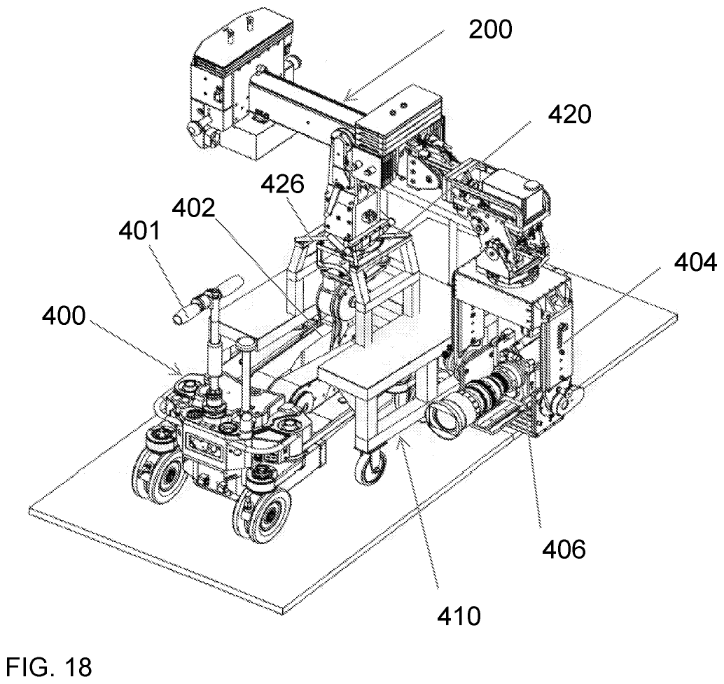

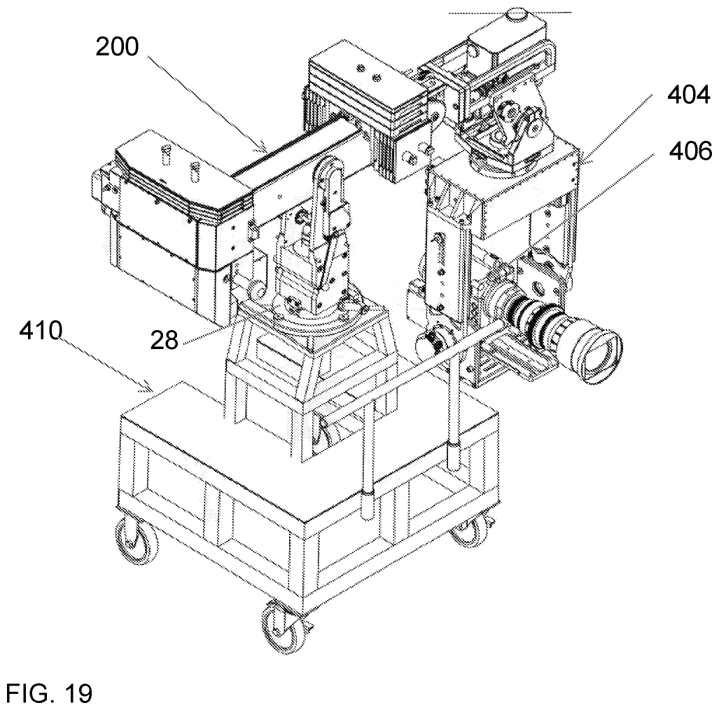

Referring to FIGS. 13 and 18, the crane 200 may be removed from the camera dolly 400 by maneuvering the camera dolly 400 into the frame opening 426 of the crane cart 410. The width of the frame opening W2 is nominally greater than the width of the chassis of the camera dolly 400. The width of the deck opening 424 is nominally greater than the width of the arm 402 of the camera dolly 400. This allows the camera dolly 400 to be moved into the crane cart 410, with the base plate 28 of the column (shown in FIG. 8) above the top plate 420 of the crane cart 410. The fastener(s) such as bolts securing the crane 200 to the dolly arm 402 are loosened and/or removed. The dolly arm 402 is then lowered to set the base plate 28 onto the top plate 420. As shown in FIG. 19, the camera dolly 400 may then be withdrawn from the crane cart 410 and used without the crane 200. The crane 200 may be secured onto the crane cart 410 using a ring nut or other hardware engaging with the threaded fitting 29 extending down from the base plate 28. In some cases the fastener(s) securing the crane 200 to the dolly arm 402 are loosened and/or removed after the crane is transferred to the crane cart.

The crane 200 may be easily moved and stored on the crane cart 410. Typically the camera 406 shown in FIG. 19 would be removed from the crane 200 for continued use directly on the camera dolly 400, or with other equipment. A camera crane 200 on the crane cart 410 may be loaded onto a camera dolly 400 using the reverse of the sequence of steps described above.

In an alternative design, four support rods 427 (shown in FIG. 8) may be inserted into side holes in the base plate 28. In this design, when the arm 402 of the camera dolly 400 is lowered to place the crane 200 onto the crane cart 410, the support rods 427 come to rest in radial grooves 425 in the top plate 420. The weight of the crane 200 is then borne by the support rods 427 when the crane 200 is stored or moved on the crane cart 410. In this design, the base plate 28 may be smaller than the width WW of the opening in the U-shaped top plate 420. Use of the support rods 427 also allows the crane cart 410 to be used with cranes having varying sizes of the base plate 28. Use of the support rods 427 also allows crane cart 410 and the openings 424 and 426 to be oversized, for use with a range of camera dollies having varying widths and types of arms. As used here, camera dolly includes pushed and self-propelled camera dollies, and wheeled camera bases and pedestals.

Thus, novel crane equipment has been shown and described. Various changes and modifications may be made without departing from the spirit and scope of the invention. The invention, therefore, should not be limited, except by the following claims and their equivalents.

1. A camera crane cart, comprising:
a frame supported on wheels;
a frame deck on the frame;
a riser on the frame extending above the frame deck;
a top plate at the top of the riser, the top plate adapted for supporting a base plate of a camera crane; and
a handle attached to a front of the frame;
each of the frame, the frame deck, the riser and the top plate having an opening to allow a camera dolly arm to move into a central location of the camera crane cart for loading or unloading a camera crane.

2. The camera crane cart of claim 1 wherein the deck has a deck opening having a width W1 extends into a center area of deck, with the deck opening having a length equal to 40 to 80% of the length of the deck.

3. The camera crane cart of claim 1 wherein the frame has a frame opening below the deck, the frame opening having a width W2, wherein W2 is 1.5 to 3 times greater than W1.

4. The camera crane cart of claim 1 wherein the top plate has a plurality of radial slots adapted to receive support rods in the base plate of a camera crane.

5. The camera crane cart of claim 2 wherein the deck opening extends from the back of the frame towards the handle.

6. A camera crane cart, comprising:
a U-shaped frame supported on wheels;
a frame deck on the frame;
a U-shaped riser on the frame extending above the frame deck;
a U-shaped top plate at the top of the U-shaped riser, the top plate adapted for supporting a base plate of a camera crane; and
a handle attached to a front of the U-shaped frame.

7. A method for unloading a camera crane from a camera dolly, comprising:
maneuvering a camera dolly carrying a camera crane on an arm of the camera dolly into an opening of a crane cart;
lowering the camera dolly arm to set the camera crane onto a top plate of a riser of the crane cart;
securing the crane to the top plate via one or more fasteners; and
withdrawing the camera dolly from the crane cart.

8. The method of claim 7 wherein the crane includes a base plate having a plurality of radially extending support rods, with the support rods coming to rest on the top plate as the camera dolly arm is lowered, to support the crane on the crane cart.

9. The method of claim 8 wherein the support rods come to rest in radial grooves in the top plate.
